(19) United States
(12) Patent Application Publication
(10) Pub. No.: US 2021/0015073 A1
(43) Pub. Date: Jan. 21, 2021

(54) SYSTEMS AND METHODS FOR CLEANING AN ANIMAL'S FOOT

(71) Applicant: Limor Arika, Dania Beach, FL (US)

(72) Inventor: Limor Arika, Dania Beach, FL (US)

(21) Appl. No.: 16/930,690

(22) Filed: Jul. 16, 2020

Related U.S. Application Data
(60) Provisional application No. 62/876,179, filed on Jul. 19, 2019.

(51) Int. Cl. A01K 1/015; A01K 13/00

(52) U.S. Cl. CPC A01K 1/0157; A01K 13/001

(57) ABSTRACT

Systems and methods for self-cleaning of an animal's feet. The apparatus includes a cleaning portion, a drying portion, and a barrier. The cleaning portion includes upward projections and a tray for retaining water. The animal, such as a dog, cleans its own feet by walking over the wet projections. The drying portion includes an absorbent upper layer supported by a lower support. The dog dries its own feet by walking over the absorbent layer which surrounds the feet on multiple sides. The barrier is deployable to various heights and configurable to restrict movement of the dog along the cleaning and drying portions, such that the dog must clean its paws prior to entering a designated clean area, such as an interior of a home.

### INCORPORATION BY REFERENCE TO ANY RELATED APPLICATIONS

Any and all applications for which a foreign or domestic priority claim is identified in the Application Data Sheet as filed with the present application are hereby incorporated by reference under 37 CFR 1.57.

This application claims the benefit of priority to U.S. provisional patent application No. 62/876,179, entitled DEVICE AND METHOD OF CLEANING AND DRYING ANIMAL PAWS and filed Jul. 19, 2019, the disclosure of which is hereby incorporated by reference herein in its entirety for all purposes and forms a part of this specification.

### BACKGROUND

### Field

The development relates generally to animal cleaning, in particular to systems and methods for self-cleaning an animal's feet.

### Description of the Related Art

Many different animals may occupy spaces that are desirable to keep clean.

When animals go outside or in otherwise dirty spaces, the dirt and other debris may be tracked back to the clean areas, such as inside a home or other dwelling. Existing solutions to cleaning animals' feet, such as a dog's paws, include manual cleaning, such as with a towel or paper towel, to clean the dog's paws by individually wiping each paw. However, dogs often resist having their paws pulled on and cleaned. Plus, the owner gets dirty from cleaning the dog's paws. Individually cleaning each paw becomes an onerous task considering dogs go outside several times a day to use the restroom, or simply to play. Other systems for cleaning animal feet are complicated and expensive. Solutions for animal feet cleaning that address these and other drawbacks to existing solutions are desirable.

### SUMMARY

The embodiments disclosed herein each have several aspects no single one of which is solely responsible for the disclosure's desirable attributes. Without limiting the scope of this disclosure, its more prominent features will now be briefly discussed. After considering this discussion, and particularly after reading the section entitled “Detailed Description” one will understand how the features of the embodiments described herein provide advantages over existing approaches to cleaning animal feet.

An object of the development is a system and method for cleaning and drying animal feet. The development may include guiding an animal with dirty feet into a cleaning station, entering the cleaning station located adjacent a barrier such as between at least two telescoping fences, the animal being guided onto the cleaning station, self-cleaning the animal feet with an upper layer of the cleaning station, and the animal being guided off the cleaning station.

These and other objects and advantages of the present development will be readily appreciable from the following description of preferred embodiments of the invention and from the accompanying drawings and claims.

The development broadly comprises a device for rinsing or otherwise cleaning an animal's feet and drying the feet. There is at least one cleaning station and at least one drying station. There may be a barrier, such as a fence or a telescoping fence. The cleaning station may positioned adjacent the barrier, such as between the telescoping fences. At least one rib may be used to support the barrier. The rib may be located under the cleaning station and be removeably connected to the barrier. The drying station is located adjacent the cleaning station.

In one aspect, an apparatus for cleaning an animal's foot is described. The apparatus comprises a cleaning portion, a drying portion and a barrier. The cleaning portion comprises a cleaning pad and a tray. The cleaning pad includes a cleaning area having a plurality of upward extending projections. The tray is configured to retain a volume of water therein. The projections are configured to be located in the tray, such that the animal's foot gets wet while stepping on the projections to rinse and remove debris from the animal's foot. The drying portion is configured to be located adjacent the cleaning portion such that the animal can step from the cleaning portion and onto the drying portion. The drying portion comprises a drying pad including a drying area having a compressible layer configured to receive the animal's foot thereon. The compressible layer is configured to compress in response to receiving the animal's foot thereon and at least partially surround the animal's foot to dry the animal's foot. The barrier is configured to stow into a transportable configuration and to deploy into a guide configuration. In the guide configuration, the barrier extends along a side of the cleaning and drying portions to form an entrance to the apparatus and with a portion of the barrier configured to be vertically located higher than upper-most surfaces of the cleaning and drying pads to guide the animal onto the cleaning portion and along the apparatus to the drying portion.

Various embodiments of the various aspects may be implemented. For example, in some embodiments, the cleaning area may include artificial grass and the projections may comprise artificial grass blades. The drying portion may further comprise a support layer configured to support the compressible layer thereon. The barrier may extend along a first side of the cleaning and drying portions and a second side of the cleaning and drying portions opposite the first side, and the barrier may extend outwardly from the first and second sides to define an entrance to the cleaning portion. The barrier may comprise first and second side portions, that extend along the first and second sides respectively, and first and second outward portions that are configured to attach to the first and second side portions respectively and extend outward away from the respective first and second sides.

In another aspect, an apparatus for cleaning an animal's foot is described. The apparatus comprises a cleaning portion and a drying portion. The cleaning portion comprises a cleaning pad including a cleaning area having a plurality of upward extending projections configured to receive an animal's foot thereon to remove debris from the animal's foot. The drying portion is configured to be located adjacent the cleaning portion such that the animal can step from the cleaning portion and onto the drying portion. The drying portion comprises a drying pad including a drying area having a compressible layer configured to receive the animal's foot thereon to dry the animal's foot.

Various embodiments of the various aspects may be implemented. For example, in some embodiments, the cleaning area may include artificial grass and the projections may comprise artificial grass blades. The cleaning area may be configured to retain a volume of water therein such that the animal's foot is wet when the foot steps on the projections. The cleaning portion may further comprise a tray configured to receive the cleaning pad therein. The tray may be configured to retain a volume of water therein to wet the animal's foot. The compressible layer may be configured to compress in response to receiving the animal's foot thereon and at least partially surround the animal's foot to dry the animal's foot. The compressible layer may comprise an absorbent foam. The drying portion may further comprise a support layer configured to support the compressible layer thereon. The apparatus may further comprise a barrier. The barrier may have a portion configured to extend along a side of the cleaning and drying portions and be vertically located higher than an upper surface of the drying pad. The barrier may be configured to deploy from a stowed configuration to a deployed configuration. The barrier may comprise a lattice structure configured to be vertically stowed and deployed.

In another aspect, a method of self-cleaning an animal's foot is described. The method comprises locating a drying portion adjacent an area intended to be kept clean, the drying portion comprising a compressible material configured to receive the animal's foot thereon and partially surround the animal's foot to dry the animal's foot after being cleaned. The method further comprises locating a cleaning portion adjacent the drying portion, such that the animal can step from the cleaning portion and onto the drying portion, where the cleaning portion comprises a plurality of upward extending projections and is configured to retain a volume of water therein such that an animal's foot will be wet when located on the projections. The method further comprises locating a barrier adjacent the cleaning and drying portions to form an entrance and an exit to the apparatus, where the entrance is located at a first end of the apparatus adjacent the cleaning portion and the exit is located at a second end of the apparatus adjacent the drying portion.

Various embodiments of the various aspects may be implemented. For example, in some embodiments, locating the cleaning and drying portions may comprise laying respectively a cleaning pad and a drying pad flat and adjacent to each other. Locating the barrier may comprise installing a fence along a side of the cleaning and drying portions. Installing a fence may comprise deploying the fence from a stowed configuration to a deployed configuration. Locating the barrier may comprise locating end portions of the barrier to partially block a doorway opening.

In another aspect, a device for cleaning and drying animal paws is described. The device comprises at least one cleaning station, at least one rib, and at least two telescoping fences. The cleaning station has an upper layer and a lower layer. The cleaning station is positioned between the telescoping fences. The rib is located under the cleaning station and is removably connected to the telescoping fences.

In another aspect, a method for cleaning and drying animal paws is described. The method comprises guiding an animal with dirty paws onto a cleaning station, where the cleaning station is located between at least two telescoping fences, walking the animal on the cleaning station, cleaning the animal paws with an upper layer of the cleaning station, and walking the animal off the cleaning station.

Various embodiments of the various aspects may be implemented. For example, in some embodiments, the projections may comprise bristles. The projections may be formed from plastic, polymer, or rubber. The cleaning area may be configured to retain the volume of water in the artificial grass. The compressible layer may depress downward farther than the support layer in response to receiving the animal's foot thereon. The barrier may comprise a fence. The barrier may extend along a first side of the cleaning and drying apparatus and a second side of the cleaning and drying apparatus opposite the first side. The barrier may extend outwardly at ninety-degrees from the first and second sides. The barrier may comprise side portions, that extend along the first and second sides, and outward portions that extend outward away from the first and second sides and that are configured to attach to respective side portions. The apparatus may further comprise a plurality of attachments configured to connect the outward portions of the barrier to the respective side portions. The support layer may comprise plastic, polymer, foam, metal, other suitable material, or combinations thereof. The barrier may be configured to guide the animal along the apparatus as the animal walks from the cleaning portion to the drying portion. The barrier may extend outwardly from the first and second sides to define an entrance to the cleaning portion. The apparatus may be configured to be located next to an entrance to a building. The apparatus may be configured to be located inside an entrance to a building. The apparatus may be configured to be located partially inside and partially outside a building. The entrance to the building may be a doorway and the building may be a home. The apparatus may further comprise a barrier having a portion configured to extend along a side of the cleaning and drying portion to guide the animal to the entrance of the building.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings. In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

FIG. 1 is a perspective view of an embodiment of an apparatus for self-cleaning an animal's feet including a cleaning portion, a drying portion, and a barrier.

FIG. 2 is a perspective view of the apparatus of FIG. 1 showing a dog walking over the cleaning portion.

FIG. 3 is an exploded view of the cleaning portion of the apparatus of FIG. 1.

FIG. 4 is an exploded view of the drying portion of the apparatus of FIG. 1.

FIG. 5 is an exploded view of another embodiment of a drying portion that may be used with the apparatus of FIG. 1.

FIG. 6 is a partial side view of the drying portion showing an animal's foot surrounded on four lateral sides by the compressed upper layer.

FIG. 7 is a flow chart showing an embodiment of a method of self-cleaning an animal's feet.

### DETAILED DESCRIPTION

The following detailed description is directed to certain specific embodiments of the animal feet cleaning development. Reference in this specification to “one embodiment,” “an embodiment,” or “in some embodiments” means that a particular feature, structure, or characteristic described in connection with the embodiment is included in at least one embodiment of the invention. The appearances of the phrases “one embodiment,” “an embodiment,” or “in some embodiments” in various places in the specification are not necessarily all referring to the same embodiment, nor are separate or alternative embodiments necessarily mutually exclusive of other embodiments. Moreover, various features are described which may be exhibited by some embodiments and not by others. Similarly, various requirements are described which may be requirements for some embodiments but may not be requirements for other embodiments.

Various embodiments of systems and methods for cleaning an animal's feet will now be described with reference to the accompanying figures, wherein like numerals refer to like elements throughout. The terminology used in the description presented herein is not intended to be interpreted in any limited or restrictive manner, simply because it is being utilized in conjunction with a detailed description of certain specific embodiments of the development. Furthermore, embodiments of the development may include several novel features, no single one of which is solely responsible for its desirable attributes or which is essential to practicing the invention described herein.

The animal cleaning developments described herein are not limited to the particular systems, devices, apparatuses, methodology, materials and modifications described and as such may, of course, vary. Further, unless defined otherwise, all technical and scientific terms used herein have the same meaning as commonly understood to one of ordinary skill in the art to which this invention belongs. It should be appreciated that the term “dog” is synonymous with terms such as “pet”, “cat”, “puppy”, “kitten”, “gecko”, “iguana”, “ferret”, “guinea pig”, etc., and such terms may be used interchangeably as appearing in the specification and claims. Although any methods, devices or materials similar or equivalent to those described herein can be used in the practice or testing of the invention, the preferred methods, devices, and materials are now described.

The development is described with respect to a dog and a home. However, other animals and clean spaces may be used. For example, the development or modifications thereto may be used with cats, horses, rabbits, turtles, iguanas, snakes, guinea pigs, birds, hamsters, and others. The development may be used inside, outside, or partially inside and partially outside, of homes, other residential buildings, commercial buildings, barns, coops, farmhouses, guest homes, vehicles, parking lots, trucks, trailers, and other dwellings or items.

The apparatus described herein may be especially useful for dogs. Dogs are widely regarded as a man's best friend. Approximately 78 million dogs live in United States households as pets. Dog owners often feel and treat a dog as a member of their family. Dogs eat when their owner eats, take walks with their owners, go swimming with the family, and oftentimes sleep in their owner's bed. Bringing a puppy or new dog home, or having a dog pass away, is often a major life event for a dog owner.

Given the close relationship between dog owners and dogs, dog owners typically keep their dogs clean by giving them regular baths or taking them to a groomer. Having a clean dog helps the owner maintain a clean home. Households with dogs span across the entire United States, with climates ranging from hot to cold, and wet to dry. Each climate brings unique challenges to keep a dog's paws clean after going outside to use the restroom, i.e., urinate and defecate.

Most owners allow a dog to use the restroom by either letting the dog outside, typically in a fenced yard, or by walking the dog on a leash through their neighborhood. Even in dry conditions, a dog's paws get dirty from dirt, sand, and other debris commonly found on the ground. When the conditions outside are wet, such as when it rains or snows, a dog's paws become wet and full of mud from the grass and other walking areas.

If the dog is allowed back into the house without cleaning their paws, it results in the dog tracking dirt and mud throughout the house, which is undesirable for most homeowners. Carpeting is left with paw prints that stain, and wood and tile floors are littered with mud and dirt, all of which creates a dirty environment inside a person's house.

Cleaning the dog's paws after they go outside, but before the dog re-enters the house, requires the owner to have a towel or paper towel to clean the dog's paws by individually wiping each paw. Usually, a damp cloth is helpful to remove the mud and dirt from the dog's paws. However, dogs often resist having their paws pulled on and cleaned. Plus, the owner gets dirty from cleaning the dog's paws. Individually cleaning each paw becomes an onerous task considering dogs go outside several times a day to use the restroom, or simply to play.

Keeping a dog's paws clean also promotes a healthy dog. Dirty paws or excessive exposure to snow and the elements can dry a dog's paws, which results in cracked paws. Mud and other debris can irritate the paws. All of these conditions can result in a dog limping. Keeping a dog's paws clean helps to avoid these conditions.

Reducing the mud and dirt on a dog's paws when entering the house also reduces cleaning bills for the owner. After repeated tracking in dirt from outside, the carpets have to be cleaned. In extreme situations, carpets are replaced. Preventing a dog from entering the house with dirty paws help home owner from the preventable expenses of cleaning and replacement of carpets and rugs.

Certain products provide boots or other shoes for dogs to walk on while outside. But not all dogs like boots or shoes on their paws and try and remove them immediately. This is not a solution for most dogs.

As can be derived from the variety of devices and methods directed at cleaning and drying an animal's paws, many means have been contemplated to accomplish the desired end, i.e., cleaning paws before entering a home. Heretofore, tradeoffs between keeping a towel handy or protective boots were required. Thus, there is a long-felt need for a device to rinse and dry animal paws. There is a further long-felt need for a method to rinse and dry animal paws.

The systems and methods described herein relate to self-cleaning an animal's feet. The animal may autonomously use an apparatus for cleaning the animal's feet without needing help from a human. The apparatus is therefore a passive apparatus. The owner may “set it and forget it.” The apparatus may be set up in a doorway, such as to a home. The apparatus may have a barrier, such as a fence, that guides the dog along cleaning and drying portions of the apparatus. The fence may stow and deploy for easy storage and transport. The fence may telescopically deploy. The cleaning portion includes a plurality of projections. The projections may be flexible members, such as artificial blades of grass. The cleaning portion may retain water therein, such that the animal's feet are wetted and then scrubbed or otherwise contacted by the projections to remove dirt or other debris. The animal then steps onto the dying portion, which is adjacent the cleaning portion. The drying portion includes a compressible layer. The layer may be foam. The layer may be absorbent. The layer may surround the animal foot on four lateral sides of the foot to dry those sides as well as the bottom of the foot. The clean area, such as inside a home, may be adjacent the drying portion. The barrier may guide the animal into the clean area.

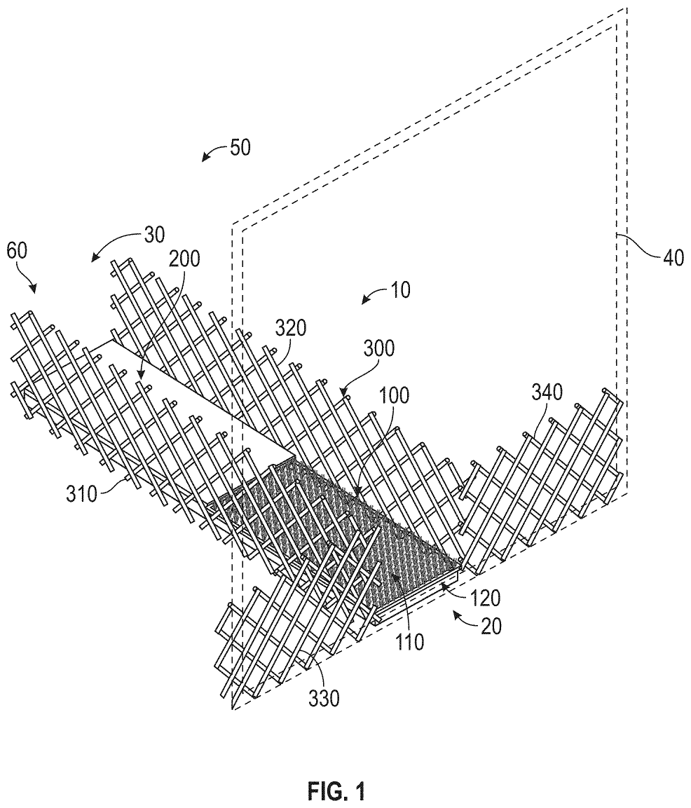

FIG. 1 is a perspective view of an embodiment of an apparatus 10 for self-cleaning an animal's feet. The apparatus includes a cleaning portion 100, a drying portion 200, and a barrier 300. Some embodiments may only include the cleaning and drying portions 100, 200.

The apparatus 10 has various uniquely desirable features. For example, the apparatus 10 allows the dog or other animal to clean their paws in a self sufficient manner, without the owner's participation. If a home doorway can remain open, the animal may independently walk in and out of the home. As further example, the apparatus 10 provides for a cleaning portion 100 providing cleaning at least in part by projections such as the artificial grass blades, which once stepped on will act as a brush reaching between the dog/animal's pads, thereby cleaning and removing dirt, mud, snow and other debris from the animal's foot. As further example, the apparatus 10 provides for a drying portion 200 which may include an absorbent material covering a foam layer. Once the absorbent material is stepped on and compressed, it will surround all surface areas of the paws thereby maximizing the drying process. As further example, the apparatus 10 includes the barrier 300, such as telescoping fences, that may be connected by ribs. The barrier 300 will guide the animal through the apparatus, will provide a border to the apparatus, will block remaining space between the device and doorway, ensuring the dog/animal is utilizing the apparatus 10, and the barrier 300 can block extra wide openings such as large doorways.

The apparatus 10 is set up next to an opening 40 of a building 50. The opening 40 may be a doorway. The opening 40 may be an opening to a home or other building. The opening 40 may have the width of a conventional doorway, or it may be wider. The opening 40 may be wide enough for French doors, sliding doors, or other openings. In some embodiments, the opening 40 may be smaller or narrower size, such as a doggy door. As shown, the apparatus 10 is set up inside the building 50. An entrance 20 to the apparatus 10 is set up at the opening 40. An exit 30 to the apparatus 10 is set up in an interior of the building 50. In some embodiments, the entrance 20 may be set up outside or on an exterior of the building 50. In some embodiments, the exit 30 may be outside the building 50, for example where other fences that form part of the existing exterior to the building 50 provide a guided walkway from the exit 30 to the interior of the building 50. A clean area 60 may be located adjacent the exit 30. The clean area 60 may be inside the building 50. The clean area 60 may be a living room, bed room, dining room, an area in front of a doggy door, or any area intended to be kept clean.

The cleaning portion 100 provides a station where the animal's feet are cleaned. The cleaning portion 100 is located adjacent the entrance 20. The cleaning portion 100 is configured and located such that an animal first walks onto the cleaning portion 100 prior to walking onto the drying portion 200. An end of the cleaning portion 100 is adjacent the entrance 20. The opposite end of the cleaning portion 100 is adjacent the drying portion 200. The cleaning portion 100 includes a cleaning area 110, as further described herein. The cleaning portion 100 may include a tray 120, as further described herein.

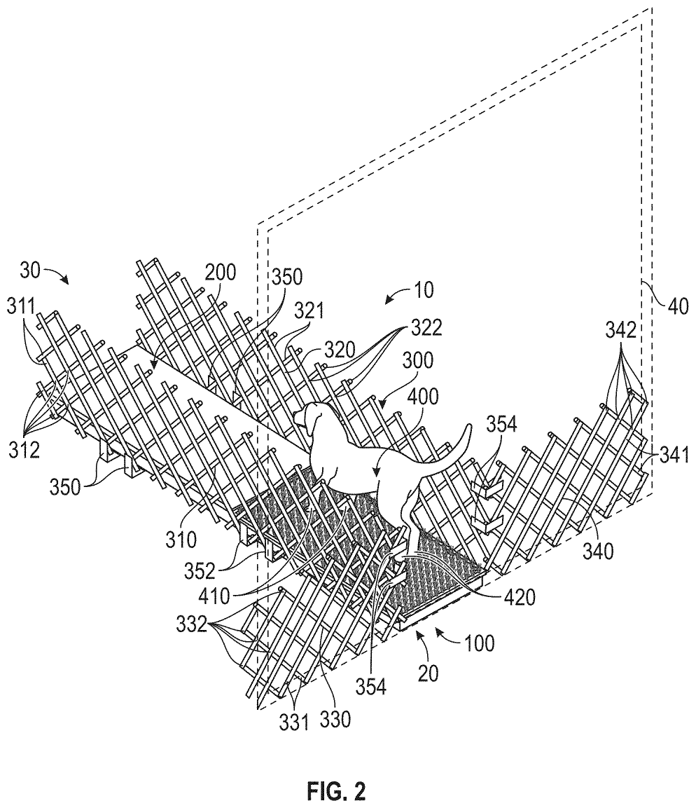

The drying portion 200 provides a station where the animal's feet are dried. The drying portion 200 is located adjacent the cleaning portion 100 such that the dog 400 (shown in FIG. 2) can step directly from the cleaning portion 100 and onto the drying portion 200. Once the dog 400 has rinsed its paws at the cleaning portion 100, the dog 400 proceeds to the drying portion 100. Although the dog's 400 paws are clean from the cleaning station, the paws remain wet. To dry the dog's 400 paws, the drying portion 200 is connected substantially flush with the cleaning portion 100 so the dog 400 can walk to the drying portion 200 without stepping on the ground or any other surface.

A first end of the drying portion 200 is adjacent an end of the cleaning portion 100. An opposite end of the drying portion 200 is adjacent the exit 30 and the clean area 60. The drying portion 200 may contact the cleaning portion 100. The drying and cleaning portions 200, 100 may be attached together, for example with brackets, fittings, other suitable attachments, or combinations thereof.

The barrier 300 extends along one or more sides of the apparatus 10. The barrier 300 as shown includes a first side portion 310 and a second side portion 320 located opposite the first side portion. In some embodiments, there may only be one side portion, such as where the apparatus 10 is installed next to a wall of the building or other natural barrier.

The side portions 310, 320 extend along sides of the cleaning and drying portions 100, 200 from the entrance 20 to the exit 30. In some embodiments, the side portions 310, 320 may extend only partially for this distance or for longer distances. The side portions 310, 320 include at least a portion that is located a vertical distance above the cleaning and drying portions 100, 200 such the animal is kept inside the barrier 300 or is otherwise discouraged from walking into the clean area 60 without first walking along the cleaning and then the drying portions 100, 200.

The barrier 300 may include one or more end portions. The barrier 300 as shown includes a first end portion 330 and a second end portion 340. The end portions 330, 340 extend outwardly away from respective ends of the side portions 310, 320. The end portions 330, 340 may extend at ninety degree angles from the side portions 310, 320, or at any other angle therefrom. As shown, the end portions 310, 320 may partially block part of the opening 40 such that the animal must walk through the entrance 20 to the apparatus 20 to enter the building 50. The end portions 330, 340 may have heights that are the same as, less than, or greater than, the side portions 310, 320. The various portions of the barrier 300 may be supported by one or more ribs as further described herein. As further described herein, the barrier 300 may stow into a stowed or transportable configuration for ease of transport. The barrier 300 may deploy into the guided configuration shown.

FIG. 2 is a perspective view of the apparatus 10 showing a dog 400 walking over the cleaning portion 100. The dog 400 has walked through the entrance 20 of its own accord and is stepping onto the cleaning portion 100. The front feet 410 and the hind feet 420 are located on top of the cleaning portion 100. The feet 410, 420 may be wetted and cleaned as the dog walks over the cleaning portion 100, as further described herein. The dog 400 may then step from the cleaning portion 100 and directly onto the drying portion 200. The drying portion 200 may dry the animal's feet 410, 420 as the dog 400 walks over it. The dog 400 may then walk into the clean area 60 of the building 50. The extended lengths of the cleaning and drying portions 100, 200 may be long enough to prevent an animal from being able to jump over either portion 100, 200.

Unless the dog 400 is well trained, dog 400 will travel off the cleaning and drying portions 100, 200 and contact the ground. This may cause additional dirt and debris to reattach to the dog's feet 410, 420. As a result, the barrier 300 may be included.

The barrier 300 may be a fence as shown. The barrier 300 may be formed from wood, plastic, polymer, metal, other suitable materials, or combinations thereof. The barrier 300 as shown includes a lattice framework. The side portion 310 includes frame members 311 rotatably joined at hinge points 312. The members 311 may rotate relative to each other about the multiple hinge points 312. For clarity only some of the members 311 and hinge points 312 are labelled in the figure. Similarly, the side portion 320 may include a plurality of frame members 321 rotatably joined at hinge points 322, the end portion 330 may include a plurality of frame members 331 rotatably joined at hinge points 332, and the end portion 340 may include a plurality of frame members 341 rotatably joined at hinge points 342. The portions 310, 320, 330, 340 may fold up into the stowed configuration having a smaller length than in the deployed configuration.

In some embodiments, the apparatus 10 may include two telescoping fences that border the cleaning and drying portions 100, 200. The cleaning and drying portions 100, 200 may be positioned between two telescoping fences. The telescoping fences may border the portions 100, 200 to keep the dog 400 contained within the cleaning and drying portions 100, 200. The overall size of the barrier 300, i.e., height and width, varying based on the size of the dog 400 being contained in the portions 100, 200.

The telescoping aspect of the barrier 300 may allow the barrier to be adjusted to fit the user's specific needs. Some users may want a longer width to keep their dog 400 contained, while other users may want a higher barrier 300 if their dog 400 jumps high. The ability of the barrier 400 to telescope and be adjusted by the user allows for a customizable device that will fit the user's specific needs. Thus the height may be adjusted using the telescoping barrier 300, such as the rotating barrier members as described herein, for example as shown in FIGS. 1 and 2. In some embodiments, the barrier 300 adjusts to increase or decrease the overall height and/or length of the barrier 300 or portions thereof. For example, as shown in FIG. 2, the side portion 310 may be adjusted in vertical height and horizontal width by rotating the members 311 about the hinge points 312. This may be done by pushing or pulling on the ends of the side portion 310. The ends of the side portion 310, for example the ends near the entrance 20 and the exit 30, may be pushed inward toward each other to increase the height and decrease the length of the side portion 310. These ends of the side portion 310 may be pulled away from each other to decrease the height and increase the length of the side portion 310. The side portion 320 may be similarly adjusted at the ends, using the members 321 rotated about hinge points 322. The end portions 330, 340 may be similarly adjusted respectively using the members 331, 341 rotated about hinge points 332, 342.

In some embodiments, the barrier 300 may form opposing L shapes. In this embodiment, the barrier 300 starts at the cleaning portion 100 and follows the outer edges of the cleaning and drying portions 100, 200 in a substantially parallel path. For example, the end portions 330, 340 may turn 90 degrees away from respective side portions 310, 320. The benefit of this configuration is that if the apparatus 10 is placed in a doorway leading into a house, then the dog 400 cannot enter the house without walking through the device. The L shaped telescoping fences abut the doorway and/or surrounding wall, thereby blocking the remaining space between the device or doorway eliminating a path for the dog to escape and dirty their paws again. In an exemplary embodiment, the left and right telescoping fences are in the shape of a U pattern, providing a path for the dog to enter the invention and restricting the dog from existing the invention closer to the doorway.

By telescoping both portions of the L shape, the telescoping fences are positioned to fit a myriad of doorways and other openings. This creates greater flexibility for the user to adjust the present invention. Moreover, the barrier 300 may be collapsible for travel. The telescoping fences collapse, thereby allowing them to be a smaller size for travel. This flexibility also allows the user to custom fit the present invention to their environment, whether at home, on vacation, or at a friend's house.

The apparatus 10 may include one or more ribs. The ribs may support and secure the barrier 300. As shown, the apparatus 10 may include first ribs 350 connecting the side portions 310, 320 to the drying portion 200. The ribs 350 may be angular brackets that attach to the barrier 300 and to the drying portion 200. The ribs 350 may have a horizontal portion located underneath the drying portion 200. The ribs 350 may have a vertical portion located adjacent the respective side portion 310, 320. The apparatus 10 may include second ribs 352 that attach to the cleaning portion 100 and the side portions 310, 320. The ribs 352 may attach in a similar manner as the ribs 350.

The apparatus 10 may include one or more third ribs 354. The ribs 354 attach adjacent portions of the barrier 300. As shown, a first set of the ribs 354 attach an end of the side portion 310 to the end portion 330 and a second set of the ribs 354 attach an end of the side portion 320 to the end portion 340. A first portion of each rib 354 may extend in a first direction and attach to a respective one of the side portions 310, 320. A second portion of each rib 354 may extend in a second direction at an angle to the first direction and attach to a respective one of the end portions 330, 340. The angle may be ninety degrees as shown, or other lesser or greater angles. The various ribs may be formed from plastic, polymer, metal, other suitable materials, or combinations thereof.

In some embodiments, the one or more ribs add support for the telescoping fences of the barrier 300. Preferably in a U-shape, the ribs may connect to both telescoping fences at the rib ends. The connections are removable to allow for simple assembly and disassembly of the apparatus 10. The rib may extend under the cleaning portion 100 to eliminate any obstruction for the dog 400 walking through the apparatus 10 to rinse and dry its feet 410, 420.

In an example embodiment, multiple ribs are used to provide added support for the telescoping faces and the stations. For configurations set up for larger dogs, multiple ribs are used to provided additional support for the apparatus 10. Additional ribs are still removably connected at the rib ends to the telescoping fences and travel underneath the cleaning and/or drying stations.

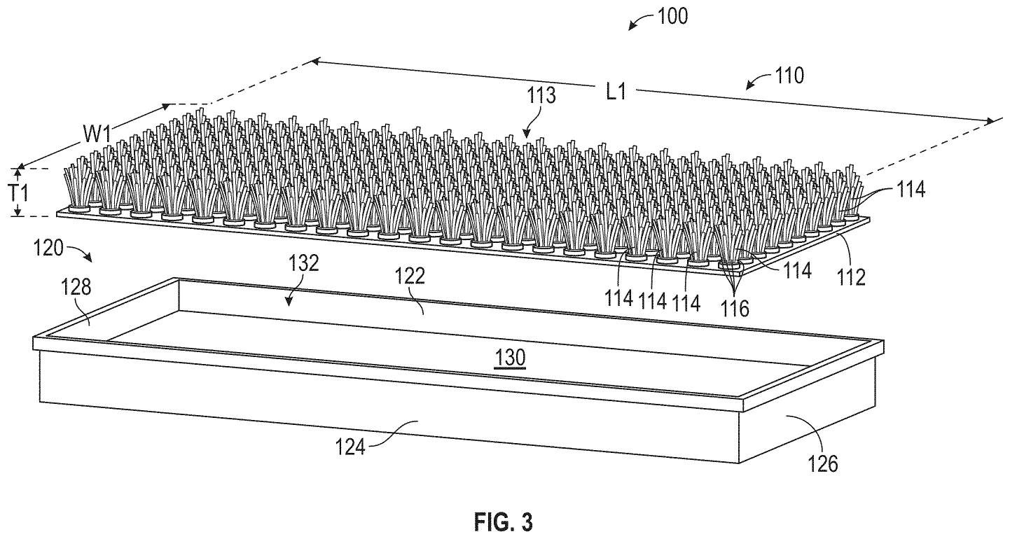

FIG. 3 is an exploded view of the cleaning portion 100. The cleaning portion 100 includes a cleaning pad 110 having a cleaning area 113. The cleaning area 113 includes a plurality of upward extending projections 116. The projections 116 may be in bundles 114, as shown. There may be a plurality of the bundles 114, with each bundle having a plurality of the projections 116. For clarity, only some of the bundles 114 and projections 116 are labelled in the figure.

The projections 116 may be formed of plastic, polymer, other suitable materials, or combinations thereof. The projections 116 may be artificial blades of grass. The projections 116 may be bristles. The projections 116, such as artificial grass blades, may be numerous varieties, such as but not limited to, polypropylene, polyethylene, nylon, astro turf, super turf, field turf, other types, or combinations thereof. In some embodiments, any type of surface with protrusions, similar to blades of grass, can be used.

The projections 116 may extend straight up, at an angle to the vertical, or combinations thereof. The projections 116 may have an axial stiffness that is greater than a beam stiffness of the individual projection. The axial stiffness may provide a cleaning force to dig into and dislodge dirt and other debris from under and within paws or other features of the animal's feet 410, 420 when the animal walks onto the projections 116.

The cleaning pad 110 may include a mat 112. The mat 112 may support the projections 116 thereon. The projections 116 may be bonded, mechanically attached, or otherwise coupled with the mat 112.

The cleaning pad 110 or area 113 may have a generally rectangular shape as shown. In some embodiments, the cleaning pad 110 may have other shapes, such as square, trapezoidal, rounded, circular, other suitable shapes, or combinations thereof. The size of the cleaning and drying portions 100, 200 vary depending on the size of the dog 400 or other animal. Smaller dogs 400 allow for smaller stations and larger dogs 400 require larger stations to adequately rinse and dry the dog's paws 410, 420. The cleaning pad 110 or area 113 may have a length L1, a width W1, and a height T1. The length L1 may be from about 2-10 feet, from about 3-8 feet, from about 4-5 feet, or other lengths. The width W1 may be from about 1-5 feet, from about 2-4 feet, about 3 feet, or other widths. The height T1 may be from about ¼-5 inches, from about ½-4 inches, from about 1-3 inches, or other heights.

The cleaning portion 100 may include a tray 120. The tray 120 may be configured to receive and secure therein the cleaning pad 110. The tray 120 may includes side walls 122, 124 and end walls 126, 128. The first side wall 122 is located opposite the second side wall 124. The first end wall 126 is located opposite the second end wall 128. The side walls attach to a lower floor 130 to form an interior volume 132 therein. The floor 130 extends from lower portions of the respective side walls. The side walls 122, 124, 126, 128 may each have a height that is the same as, lower than, or taller than the height T1 of the projections 116. The ribs 352 may attach to the side walls 122, 124 and/or to the floor 130. The side walls 122, 124 may extend along sides of the apparatus 10 and have side portions 310, 320 extending along these sides. The first end of the cleaning pad 110 and/or the first end wall 126 of the tray 120 may be located at or adjacent the entrance 20 to the apparatus 10, such as at the opening 40 of the building 50. The second end of the cleaning pad 110 and/or the second end wall 128 of the tray 120 may be located adjacent an end of the drying portion 200.

The volume 132 may retain water and/or another liquid. In some embodiments, regular tap water or water from a hose is put into the volume 132. In some embodiments, cleaner or other liquids or put into or mixed into the volume 132. The cleaning pad 110 is put into the tray 120 such that the animal's feet 410, 420 are wetted by the water and also scrubbed by the projections 116. Thus any dirt or debris on the feet 410, 420 will be wet and therefore softer and easier to wipe off with the projections 116. The projections 116 then contact and scrape the debris from the fee 410, 420 due to the weight of the dog 400 and the axial stiffness of the projections 116. The upper ends of the projections 116 may extend above the water line. In some embodiments, half or more of the axial length of the projections 116 may extend above the water line. In some embodiments, the projections 116 may be located below the water line.

In some embodiments, the cleaning portion 100 includes an upper layer and a lower layer. The upper layer of the cleaning portion 100 is made of artificial grass. The artificial grass is placed in the tray 120. When a dog walks onto the cleaning portion 100, the dog's paws touch the artificial grass. The numerous blades of the artificial grass make contact with the dog's paws and lower legs. As the dog walks on the artificial grass, the blades of artificial grass and water rinse and clean the dog's paws. The blades of grass aid to remove dirt, mud, snow, and other debris from a dog's paws.

In other embodiments, the lower layer includes the tray 120 having a layer of foam placed on top of the tray 120. Water is poured into the tray, which saturates the foam. The tray is filled with sufficient water to saturate the foam.

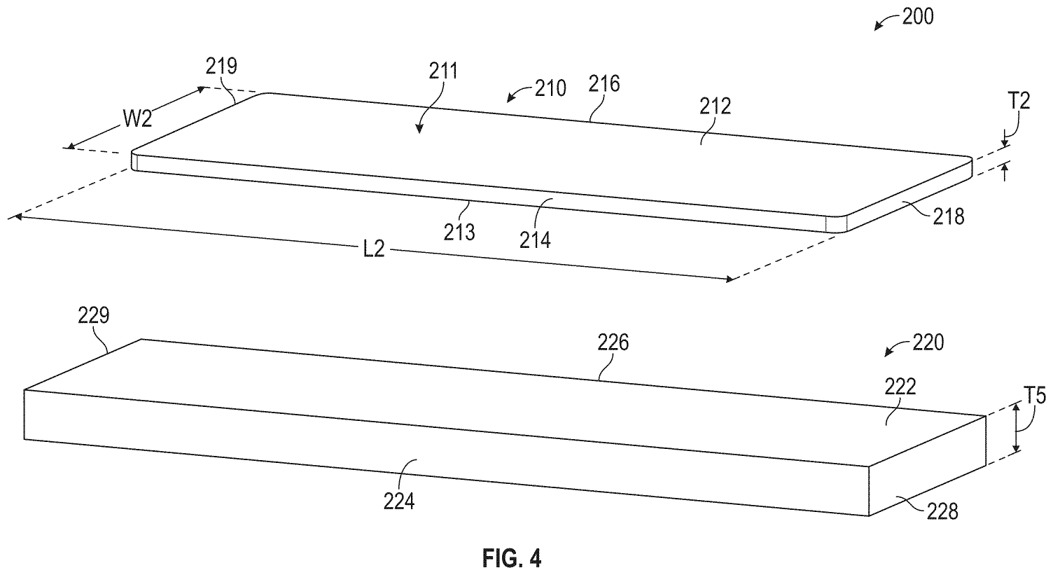

FIG. 4 is an exploded view of the drying portion 200. The drying portion 200 includes a drying pad 210 having a drying area 211. The drying area 211 is configured to receive the animal's feet 410, 420 therein to remove water from the feet that was picked up in the cleaning portion 100. The drying pad 210 includes an upper surface 212, an opposite lower surface 213, a first side 214 opposite a second side 216, and a first end 218 opposite a second end 219. The drying pad 210 may be formed of an absorbent, compressible material. The drying pad 210 may be foam. The drying pad 210 is configured to compress in response to receiving the animal's feet 410, 420 thereon and at least partially surround the animal's feet 410, 420 to dry the animal's feet 410, 420.

The drying pad 210 may have a length L2, a width W2, and a thickness T2. The length L2 may extend from the first end 218 to the second end 219. The width W2 may extend from the first side 214 to the second side 216. The thickness T2 may extend from the lower surface 213 to the upper surface 212. The length L2 may be from about 2-10 feet, from about 3-8 feet, from about 4-5 feet, or other lengths. The width W2 may be from about 1-5 feet, from about 2-4 feet, about 3 feet, or other widths. The height T2 may be from about ¼-5 inches, from about ½-4 inches, from about 1-3 inches, or other heights. The length L2 and width W2 of the drying pad 210 may be the same as or similar to respectively the length L1 and width W2 of the cleaning pad 110.

The upper surface 212 of the drying pad 210 may be located at a select vertical height relative to the barrier 300. The barrier 300 may have a portion or portions that are located a vertical distance above the upper surface 212 of the drying pad 210 such that the dog 400 is prevented or discouraged from exiting the apparatus 10 over or through the side portions 310, 320 of the barrier 300. The barrier 300 may extend to upper ends located a first distance above the upper surface 212. The upper ends of the barrier may be located 1 or more feet, 2 or more feet, 3 or more feet, 4 or more feet, 5 or more feet, or higher vertically above the upper surface 212. The upper ends of the barrier may be located vertically at the same or similar heights above upper-most ends of the projections 116 of the cleaning portion 100.

The drying portion 200 may include a lower support 220. The support 220 may be a support structure or lower layer for the drying portion 200 on top of which the drying pad 210 is located. The support 220 may include a first side 224 opposite a second side 226 and a first end 228 opposite a second end 229. The sides 224, 226 of the support 220 may have the same or similar dimensions as the sides 214, 216 of the drying pad 210. The ends 228, 229 of the support 220 may have the same or similar dimensions as the sides 218, 219 of the drying pad 210. The support 220 may have a rectangular planform as shown. The support 220 may have other suitable shapes. The planform of the support 220 may correspond to the planform of the drying pad 210. The sides 224, 226 of the support 220 and the sides 214, 216 of the drying pad 210 may extend along sides of the apparatus 10 and have the side portions 310, 320 extending along these sides. The first end 218 of the drying pad 210 and the first end 228 of the support 220 may be located adjacent to the drying portion 100. The second end 219 of the drying pad 210 and the second end 229 of the support 220 may be located adjacent to the clean area 60 or otherwise inside or adjacent to the building 50.

The support 220 may provide additional stiffness to the drying portion 220. The support 220 may compress slightly when the animal feet 410, 420 step on the drying pad 210. The animal feet 410, 420 may cause the drying pad 210 to compress downward proportionally more than the support 220 in response to downward pressure from the animal's feet 410, 420. The support 220 may therefore be stiffer than the drying pad 210 in a downward direction. In some embodiments, the support 220 may compress very little or not at all in response to the downward pressure. The support 220 may be formed of plastic, polymer, metal, other suitable materials, or combinations thereof. The drying pad 210 may rest on top of the support 220. The drying pad 210 may be bonded to, fastened to, or otherwise coupled with the support 220. The drying pad 210 may be removeably attached to the support 220. The drying pad 210 may be removed and cleaned and then re-attached to the support 220.

The support 220 may include an upper surface 222. The drying pad 210 may rest on or attach to the upper surface 222. The upper surface 222 of the support 220 may be flat or horizontal as shown. The upper surface 22 may extend from the first side 224 to the second side 226 and from the first end 228 to the second end 229. The upper surface 222 may be flat, rounded, curvy, segmented, other shapes or contours, or combinations thereof. The upper surface 222 may be configured to vertically position the drying pad 210 at a desirable height.

In some embodiments, an upper layer of the drying portion 200 includes the drying pad 210 and a lower layer of the drying portion 200 includes the support 220. When the dog 400 walks into the drying portion 200, the dog's front feet 410 make contact with the upper layer. This causes the moisture on the dog's feet 410, from the cleaning portion 100, to absorb into the upper drying surface. It is advantageous for the dog to take several steps on the upper drying surface to maximize the absorption of moisture from the dog's paws to the drying surface. In some embodiments, the drying portion 200 or parts thereof may include a cover. The support 220 may include the cover. The drying pad 210 may include the cover. The cover may be removeable. The cover may have a zipper for easy removal. The cover may be washable. The cover may be formed of cotton or other washable material. The cover may completely surround and shield from the elements the part or parts over which the cover is applied.

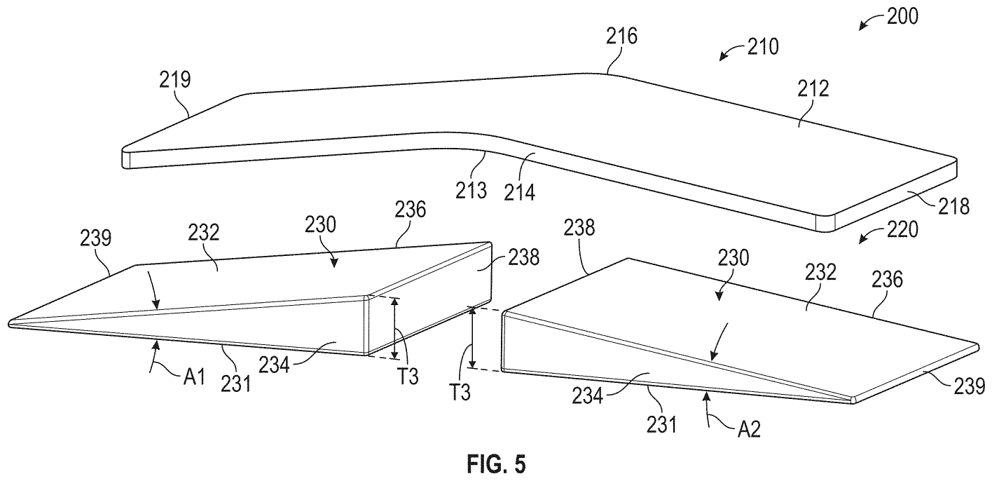

FIG. 5 is an exploded view of another embodiment of a drying portion 201 that may be used with the apparatus 10. The drying portion 210 may have the same or similar features and/or functions as the drying portion 200 except as otherwise described herein. The drying portion 201 thus includes the drying pad 210, as described.

The drying portion 210 further includes an angled lower support 221. The support 221 includes two incline portions 230. The incline portions 230 ramp and then down as the dog 400 walks over the drying portion 210. Each incline portion 230 includes an upper surface 232 and an opposite lower surface 231, a first side 234 opposite s second side 236, and a first end 238 opposite a second end 239. The upper surfaces 232 are angled with respect to the lower surfaces 231 at angles A1 and A2 respectively. The angle A1 may be from about 10-60 degrees, from about 15-45 degree, from about 20-30 degrees, or other angular amounts. The angle A2 may be the same as, greater than, or less than the angle A1. The portions 230 may be located adjacent each other to form a continuous incline and decline. As shown, the portions 230 are separated for clarity. As shown, the drying pad 210 may have a similar angled shape when coupled with the support 221. The drying pad 210 may thus incline as the dog walks onto the drying portion 201 and then decline as the dog walks off the drying portion 201.

In an example embodiment, the lower layer of the cleaning station and the lower support pad of the drying station are shaped as upward and downward ramps, respectively. For instance, the foam in the lower layer of the cleaning station ramps upwards, as if the dog was walking up a hill. At the point where the cleaning station meets the drying station, the lower support pad of the drying station ramps downward, as if the dog was walking down a hill. This configuration leaves an apex, i.e., the top of the hill, where the cleaning station meets the drying station. Utilizing a ramp configuration provides additional surface area for the dog to walk, thereby increasing the amount of cleaning and drying of the dog's paws. Additionally, the ramp is appealing to dogs as it creates a challenge for them to ascent and descent. This makes the paw cleaning and drying process a challenging task for the dog.

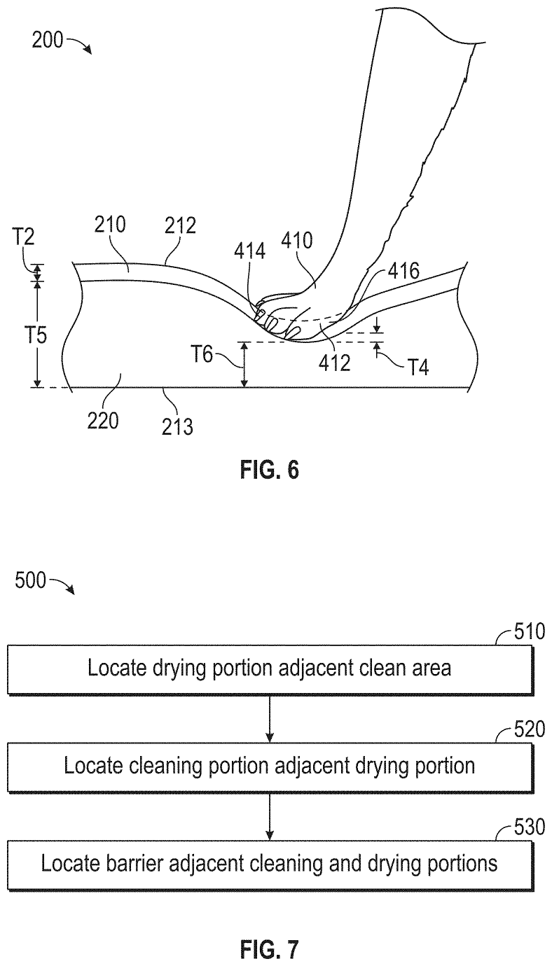

FIG. 6 is a partial side view of the drying portion 200 showing the animal's foot 410 surrounded on four lateral sides by the compressed drying pad 210. The upper surface 212 of the drying pad is absorbing moisture from and drying the underside of the animal's foot 410. The animal's foot also has a front side 414, a rear side 416, and two lateral sides 412. The drying pad 210 is configured such that the weight of the dog 400 will cause the drying pad 210 to compress and surround the foot 410 to thereby dry the front side 414, rear side, 416, and tow lateral sides 412 of the foot 410. In some embodiments, the drying pad 210 may partially contact the upper side of the animal's foot 410. The drying pad 410 therefore removes moisture from multiple sides of the foot 410 and provides a superior drying effect to the foot 410.

The drying pad 210 may have an uncompressed thickness T2 and a compressed thickness T4. The compressed thickness T4 may be the thickness of the drying pad 210 that is directly underneath the foot 410. The thickness T4 may be 75% or more, 60% or more, 50% or more, 40% or more, or 25% or more of the thickness of T2. In some embodiments, the thickness T4 may be 90% or less, 80% or less, 70% or less, 60% or less, 50% or less, 40% or less, or 25% or less of the thickness of T2. The lower support 220 may be formed of a compressible material, such as foam, as described. The lower support 220 may be less compressible than the drying pad. As shown, the lower support may have an uncompressed thickness T5 and a compressed thickness T6. The thickness T6 may be 90% or more, 80% or more, 70% or more, 60% or more, or 50% or more of the thickness of T5. In some embodiments, the thickness T6 may be 95% or less, 90% or less, 85% or less, 80% or less, 75% or less, 70% or less, or 65% or less of the thickness of T5. For a given weight applied to the drying portion 200 by a foot 410, a first ratio of the compressed thickness T6 to the uncompressed thickness T5 for the lower support 220 may be less than a second ratio of the compressed thickness T4 to the uncompressed thickness T2 for the drying pad 210. Thus, the drying pad 210 may compress proportionally more than the lower support 220. In some embodiments, the lower support 220 may be thicker than the drying pad 210 (T5>T2), and thus the absolute amount or dimensional measurement of compression of the lower support 220 may be greater than the absolute amount of compression of the drying pad 210.

FIG. 7 is a flow chart showing an embodiment of a method 500 of self-cleaning an animal's feet. The method 500 may be used with the apparatus 10. The method 500 begins with step 510 where the drying portion 200 is located adjacent the clean area 60. Step 510 may include putting the support 220 on the ground and putting the drying pad 210 on top of the support 220.

The method 500 then moves to step 520 where the cleaning portion 100 is located adjacent the drying portion 200. Step 520 may include putting the tray 120 on the ground adjacent the drying portion 200 and/or adjacent the opening 40 of the building 50 and putting the cleaning pad 110 into the tray 120. Step 520 may also include wetting the cleaning portion 100, for example flowing water into the volume 132 of the tray 120.

The method 500 then moves to step 530 where the barrier 300 is located adjacent the cleaning and drying portions 100, 200. Step 530 may include deploying and assembling the side portions 310, 320 along the sides of the apparatus 10. Step 530 may include deploying and assembling end portions 330, 340 along ends of the apparatus 10, such as attached to ends of the respective side portions 310, 320. Step 530 may include securing the barrier 300 using the various ribs as described herein.

In some embodiments, the method 500 is used with the apparatus 10 to guide the dog 400 with dirty feet 410, 420 onto the cleaning portion 100. The cleaning portion 100 may be positioned between two telescoping fences of the barrier 300 and keeps the dog 400 contained within the apparatus 10 for optimal use. The dog 400 walks onto the cleaning portion 100, that may includes the upper and lower layers described herein. By walking on the cleaning portion 100, the dog's feet 410, 420, such as its paws, are rinsed and cleaned before entering the owner's house or dwelling.

The method 500 may further include, after the cleaning is complete, the dog continues walking inside the apparatus 10 to the drying portion 200, which follows the cleaning portion 100 between the telescoping fences. By walking on the drying portion 200, the dog's paws make contact with absorbent material to reduce the amount of water on the dog's paws. Once the dog's paws are dried, the dog 400 walks off or is walked off the drying portion 200 and off the apparatus 10, into the house or dwelling of the owner.

Although the term dog is used as an example of a pet with paws that are rinsed and dried using the present invention, any kind of pet or animal, including a human being, can utilize the advantages of the present invention to rinse and dry their paws or feet.

While the above detailed description has shown, described, and pointed out novel features of the invention as applied to various embodiments, it will be understood that various omissions, substitutions, and changes in the form and details of the device or process illustrated may be made by those skilled in the art without departing from the spirit of the invention. As will be recognized, the present invention may be embodied within a form that does not provide all of the features and benefits set forth herein, as some features may be used or practiced separately from others. The scope of the invention is indicated by the appended claims rather than by the foregoing description. All changes which come within the meaning and range of equivalency of the claims are to be embraced within their scope.

The foregoing description details certain embodiments of the systems, devices, and methods disclosed herein. It will be appreciated, however, that no matter how detailed the foregoing appears in text, the systems, devices, and methods may be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment may be included with other depicted embodiments in any combination. For example, any of the various components described herein and/or depicted in the Figures may be combined, interchanged or excluded from other embodiments.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

All numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches. For example, terms such as about, approximately, substantially, and the like may represent a percentage relative deviation, in various embodiments, of ±1%, ±5%, ±10%, or ±20%.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. An apparatus for cleaning an animal's foot, the apparatus comprising:
a cleaning portion comprising:
a cleaning pad including a cleaning area having a plurality of upward extending projections, and
a tray configured to retain a volume of water therein, wherein the projections are configured to be located in the tray, such that the animal's foot gets wet while stepping on the projections to rinse and remove debris from the animal's foot;
a drying portion configured to be located adjacent the cleaning portion such that the animal can step from the cleaning portion and onto the drying portion, the drying portion comprising:
a drying pad including a drying area having a compressible layer configured to receive the animal's foot thereon, the compressible layer configured to compress in response to receiving the animal's foot thereon and at least partially surround the animal's foot to dry the animal's foot; and
a barrier configured to stow into a transportable configuration and to deploy into a guide configuration, wherein in the guide configuration the barrier extends along a side of the cleaning and drying portions to form an entrance to the apparatus and with a portion of the barrier configured to be vertically located higher than upper-most surfaces of the cleaning and drying pads to guide the animal onto the cleaning portion and along the apparatus to the drying portion.

2. The apparatus of claim 1, wherein the cleaning area includes artificial grass and the projections comprise artificial grass blades.

3. The apparatus of claim 1, wherein the drying portion further comprises a support layer configured to support the compressible layer thereon.

4. The apparatus of claim 1, wherein the barrier extends along a first side of the cleaning and drying portions and a second side of the cleaning and drying portions opposite the first side, wherein the barrier extends outwardly from the first and second sides to define an entrance to the cleaning portion.

5. The apparatus of claim 4, wherein the barrier comprises first and second side portions, that extend along the first and second sides respectively, and first and second outward portions that are configured to attach to the first and second side portions respectively and extend outward away from the respective first and second sides.

6. An apparatus for cleaning an animal's foot, the apparatus comprising:
a cleaning portion comprising:
a cleaning pad including a cleaning area having a plurality of upward extending projections configured to receive an animal's foot thereon to remove debris from the animal's foot; and
a drying portion configured to be located adjacent the cleaning portion such that the animal can step from the cleaning portion and onto the drying portion, the drying portion comprising:
a drying pad including a drying area having a compressible layer configured to receive the animal's foot thereon to dry the animal's foot.

7. The apparatus of claim 6, wherein the cleaning area includes artificial grass and the projections comprise artificial grass blades.

8. The apparatus of claim 6, wherein the cleaning area is configured to retain a volume of water therein such that the animal's foot is wet when the foot steps on the projections.

9. The apparatus of claim 6, wherein the cleaning portion further comprises a tray configured to receive the cleaning pad therein.

10. The apparatus of claim 9, wherein the tray is configured to retain a volume of water therein to wet the animal's foot.

11. The apparatus of claim 6, wherein the compressible layer is configured to compress in response to receiving the animal's foot thereon and at least partially surround the animal's foot to dry the animal's foot.

12. The apparatus of claim 6, wherein the compressible layer comprises an absorbent foam.

13. The apparatus of claim 6, wherein the drying portion further comprises a support layer configured to support the compressible layer thereon.

14. The apparatus of claim 6, further comprising a barrier, the barrier having a portion configured to extend along a side of the cleaning and drying portions and be vertically located higher than an upper surface of the drying pad.

15. The apparatus of claim 14, wherein the barrier is configured to deploy from a stowed configuration to a deployed configuration.

16. The apparatus of claim 15, wherein the barrier comprises a lattice structure configured to be vertically stowed and deployed.

17. A method of self-cleaning an animal's foot, the method comprising:
locating a drying portion adjacent an area intended to be kept clean, the drying portion comprising a compressible material configured to receive the animal's foot thereon and partially surround the animal's foot to dry the animal's foot after being cleaned;
locating a cleaning portion adjacent the drying portion, such that the animal can step from the cleaning portion and onto the drying portion, the cleaning portion comprising a plurality of upward extending projections and configured to retain a volume of water therein such that an animal's foot will be wet when located on the projections; and
locating a barrier adjacent the cleaning and drying portions to form an entrance and an exit to the apparatus, the entrance located at a first end of the apparatus adjacent the cleaning portion and the exit located at a second end of the apparatus adjacent the drying portion.

18. The method of claim 17, wherein locating the cleaning and drying portions comprises laying respectively a cleaning pad and a drying pad flat and adjacent to each other.

19. The method of claim 17, wherein locating the barrier comprises deploying the fence from a stowed configuration to a deployed configuration.

20. The method of claim 17, wherein locating the barrier comprises locating end portions of the barrier to partially block a doorway opening.
